(19) United States
(12) Patent Application Publication
(10) Pub. No.: US 2014/0240354 A1
(43) Pub. Date: Aug. 28, 2014

(54) AUGMENTED REALITY APPARATUS AND METHOD

(71) Applicant: Samsung Electronics Co., Ltd., Suwon-si (KR)

(72) Inventors: Gengyu MA, Beijing (CN); Xu ZHANG, Beijing (CN); Ji-yeun KIM, Seoul (KR); Jung-uk CHO, Hwaseong-si (KR); Young-su MOON, Seoul (KR)

(73) Assignee: Samsung Electronics Co., Ltd., Suwon-si (KR)

(21) Appl. No.: 14/193,411

(22) Filed: Feb. 28, 2014

(30) Foreign Application Priority Data
Feb. 28, 2013 (CN) 201310063294.8
Feb. 20, 2014 (KR) 10-2014-0019692

(51) Int. Cl. G06T 19/00

(52) U.S. Cl. CPC G06T 19/006
USPC 345/633

(57) ABSTRACT

An augmented reality apparatus includes a plurality of photographing modules separated from each other, capturing images of a real scene that includes an object; a tracking unit obtaining status information of the object by tracking the object in the images of the real scene; an image processor determining status information of a virtual image that corresponds to the real scene based on the status information of the object, and generating an augmented reality image by combining the virtual image and the images of the real scene based on the determined status information; and a rendering unit rendering the augmented reality image to display the augmented reality image.

### CROSS-REFERENCE TO RELATED APPLICATIONS

This application claims the benefit of Chinese Patent Application No. 201310063294.8, filed Feb. 28, 2013, in the State Intellectual Property Office of the People's Republic of China, and Korean Patent Application No. 10-2014-0019692, filed on Feb. 20, 2014, in the Korean Intellectual Property Office, the disclosures of which are incorporated herein by reference.

### BACKGROUND

1. Field

The following description relates to an augmented reality apparatus and method, and more particularly, to an augmented reality apparatus and method for providing a virtual clothing service.

2. Description of the Related Art

Augmented reality, which is a field of virtual reality, is a computer-generated graphic in which a virtual material or information is combined with a real environment to show the virtual material as a material that actually exists in the real environment.

Augmented reality technology is related to human-computer interaction, and may overlay a virtual material on an image of the real world. The augmented reality, based on interactivity and imagination, is a high quality “human-computer interface” of a computer. By using a virtual reality system, a user may not only be able to feel as if the user is actually experiencing a physical world, but also obtain unrealistic experiences without any limitations of space, time, etc.

Due to its rapid development, the augmented reality technology is being applied to various fields, and accordingly, content display methods are being diversified.

### SUMMARY

The following description relates to an augmented reality method and apparatus, in which images of a real scene that includes an object are captured from a plurality of viewing angles, status information of a virtual image are determined based on status information obtained from the object, and the virtual image and the images of the real scene are combined based on the determined status information; and thus, an augmented reality image is rendered.

Additional aspects will be set forth in part in the description which follows and, in part, will be apparent from the description, or may be learned by practice of the presented embodiments.

According to an aspect of the present disclosure, an augmented reality apparatus includes a plurality of photographing modules that are separated from each other, the plurality of photographing modules capturing images of a real scene that includes an object; a tracking unit obtaining status information of the object by tracking the object in the images of the real scene; an image processor determining status information of a virtual image that corresponds to the real scene based on the status information of the object, and generating an augmented reality image by combining the virtual image and the images of the real scene based on the determined status information of the virtual image; and a rendering unit rendering the augmented reality image to display the augmented reality image.

Based on the status information of the virtual image, the image processor may generate a transparent model that corresponds to the object, and then may overlay the transparent model on the object to generate a screening effect between the virtual image and the object.

Based on the status information of the object, the image processor may generate a transparent model that corresponds to the object, and then may overlay the transparent model on the object to generate a screening effect between the virtual image and the object.

The rendering unit may include a plurality of renderable cameras which may be used to render the virtual image and the images of the real scene.

The virtual image may be a virtual glasses image, the plurality of photographing modules may include a first camera and a second camera, at least one of the first and second cameras may include the tracking unit, and the first camera may capture an image of the real scene from a left side, and the second camera may capture an image of the real scene from a right side.

The image processor may use at least one of the first and second cameras that includes the tracking unit from among the first and second camera to track a head of the object and thus obtain status information of the head of the object; determine status information of the virtual glasses image that corresponds to the real scene based on the status information of the head of the object; and generate an augmented reality image by overlaying the virtual glasses image on the head of the object based on the determined status information.

The virtual image may be a virtual clothing image. The plurality of photographing modules may include a first camera and a second camera. At least one of the first and second cameras may include the tracking unit. The first camera may capture an image of the real scene from a left side, and the second camera may capture an image of the real scene from a right side.

The image processor may include a depth sensor for obtaining shape information of the object, may determine shape information of the virtual clothing image based on the shape information of the object that is obtained by the depth sensor, may change a shape of the virtual clothing image based on the determined shape information, and may generate an augmented reality image by overlaying a changed virtual clothing image on the object. The rendering unit may render the augmented reality image at the left and right sides from which the images of the real scene are captured.

The plurality of photographing modules may include a plurality of tracking cameras including a tracking unit, the rendering unit may include a plurality of renderable cameras, and respective parameters of the plurality of renderable cameras may be determined correspondingly to respective parameters of the plurality of tracking cameras.

A display unit displaying a rendered augmented reality image may be further included.

According to an aspect of the present disclosure, an augmented reality method includes capturing images of a real scene that includes an object from a plurality of viewing angles; obtaining status information of the object by tracking the object in the images of the real scene; determining status information of a virtual image that corresponds to the real scene based on the status information of the object; generating an augmented reality image by combining the virtual image and the images of the real scene based on the determined status information; and rendering the augmented reality image.

The generating of the augmented reality image may include generating a transparent model that corresponds to the object based on the status information of the virtual image; overlaying the transparent model on the object to generate a screening effect between the virtual image and the object; and generating an augmented reality image to which the screening effect is applied by combining the virtual image and the images of the real scene.

The generating of the augmented reality image may include generating a transparent model that corresponds to the object based on the status information of the object; overlaying the transparent model on the object to generate a screening effect between the virtual image and the object; and generating an augmented reality image to which the screening effect is applied by combining the virtual image and the images of the real scene.

The rendering of the augmented reality image may include rendering the virtual image and the images of the real scene by using a plurality of rendering units.

The virtual image may be a virtual glasses image, and the images of the real scene may be captured from a left side and a right side.

The obtaining of the status information of the object may include using at least one of the images of the real scene captured from the left and right sides, tracking a head of the object, and obtaining status information of the head of the object. The determining of the status information of the virtual image may include determining status information of the virtual glasses image that corresponds to the real scene based on the status information of the head of the object. The generating of the augmented reality image may include generating an augmented reality image by overlaying the virtual glasses image on the head of the object based on the determined status information. The rendering of the augmented reality image may include rendering the augmented reality image at the left and right sides from which the images of the real scene are captured.

The virtual image may be a virtual clothing image, and the images of the real scene may be captured from a left side and a right side.

The obtaining of the status information of the object may include using a depth sensor to obtain shape information of the object. The determining of the status information of the object may include determining shape information of the virtual clothing image based on the shape information of the object obtained by the depth sensor. The generating of the augmented reality image may include changing a shape of the virtual clothing image based on the determined shape information, and generating an augmented reality image by overlaying the changed virtual clothing image on the object. The rendering of the augmented reality image may include rendering the augmented reality image at the left and right sides.

According to an aspect of the present disclosure, a non-transitory computer-readable recording medium having recorded thereon a program, which, when executed by a computer, performs the method.

### BRIEF DESCRIPTION OF THE DRAWINGS

These and/or other aspects will become apparent and more readily appreciated from the following description of the embodiments, taken in conjunction with the accompanying drawings in which:

FIG. 1 is a block diagram of a structure of an augmented reality apparatus, according to an embodiment of the present disclosure;

FIG. 2 is a view for describing the augmented reality apparatus displaying an augmented reality image, according to an embodiment of the present disclosure;

FIG. 3 is a view of the augmented reality apparatus providing a virtual glasses try-on service, according to an embodiment of the present disclosure;

FIG. 4 is a data structure of the augmented reality apparatus providing the virtual glasses try-on service, according to an embodiment of the present disclosure;

FIGS. 5A, 5B, and 5C illustrate generating a screening effect by using a transparent model of an object, according to an embodiment of the present disclosure;

FIGS. 6 and 7 are views of the augmented reality apparatus providing a virtual clothing try-on service, according to an embodiment of the present disclosure; and

FIG. 8 is a flowchart of an augmented reality method, according to an embodiment of the present disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Throughout the specification, it will also be understood that when an element is referred to as being “connected to” another element, it can be directly connected to the other element, or electrically connected to the other element while intervening elements may also be present. Also, when a part “includes” or “comprises” an element, unless there is a particular description contrary thereto, the part can further include other elements, not excluding the other elements.

In the specification, “virtual try-on” indicates a user trying on virtual clothing, hats, glasses, shoes, accessories, etc. by using augmented reality technology.

In the specification, “screening effect” indicates an effect of when a virtual image is combined with an image of a real scene, a portion of the virtual image that is to be located at the back of the object and be covered by the object is not shown on a display.

In the specification, “tracking” indicates trailing a location, a shape, motions, etc. of an object in the image of the real scene to combine the image of the real scene and the virtual image.

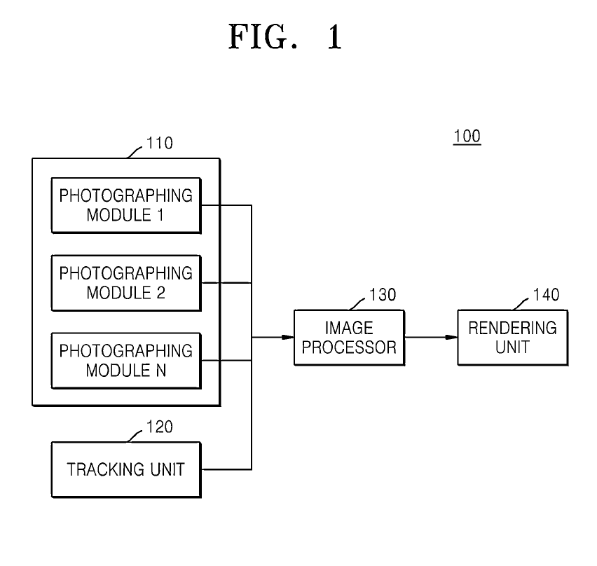

FIG. 1 is a block diagram of a structure of an augmented reality apparatus 100, according to an embodiment of the present disclosure.

The augmented reality apparatus 100 according to an embodiment of the present disclosure includes a plurality of photographing modules 110, a tracking unit 120, an image processor 130, and a rendering unit 140.

The plurality of photographing modules 110 according to an embodiment of the present disclosure are separated from each other and capture images of a real scene that includes an object.

The plurality of photographing modules 110 according to an embodiment of the present disclosure may include a toed-in 3-dimesional (3D) camera, a half mirror 3D camera, and a parallel 3D camera, but are not limited thereto.

The plurality of photographing modules 110 may include a tracking camera that includes the tracking unit 120.

The tracking unit 120 according to an embodiment of the present disclosure detects and tracks the object, and thus, obtains status information of the object.

The tracking unit 120 according to an embodiment of the present disclosure may be included in at least one of the plurality of photographing modules 110.

The image processor 130 according to an embodiment of the present disclosure determines status information of a virtual image that corresponds to the real scene, based on the status information of the object. Also, the image processor 130 generates an augmented reality image by combining the virtual image and the images of the real scene based on the determined status information of the virtual image.

Based on the status information of the virtual image, the image processor 130 according to an embodiment of the present disclosure may generate a transparent model that corresponds to the object, and then overlay the transparent model on the object to generate a screening effect between the virtual image and the object.

Alternatively, based on the status information of the object, the image processor 130 may generate a transparent model that corresponds to the object, and then overlay the transparent model on the object to generate a screening effect between the virtual image and the object.

The rendering unit 140 according to an embodiment of the present disclosure renders the augmented reality image to display the augmented reality image.

The rendering unit 140 according to an embodiment of the present disclosure includes a plurality of renderable cameras which may be used to render the virtual image and the images of the real scene.

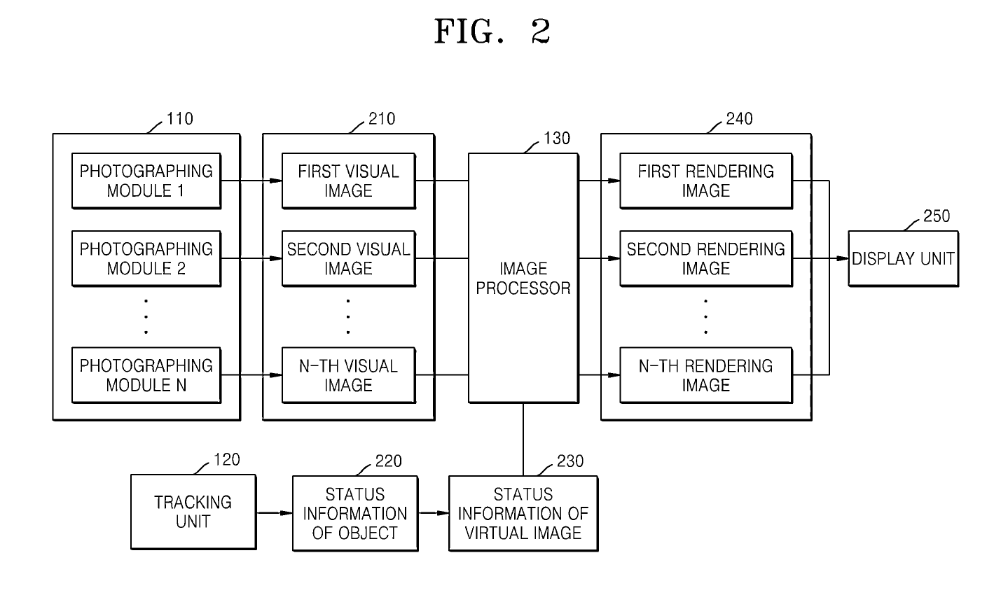

FIG. 2 is a view for describing the augmented reality apparatus 100 displaying the augmented reality image, according to an embodiment of the present disclosure.

The plurality of photographing modules 110 according to an embodiment of the present disclosure may include a plurality of cameras. The plurality of photographing modules 110 may be separated from each other and capture the images of the real scene that includes the object. For example, a photographing module 1 may capture a first visual image, a photographing module 2 may capture a second visual image, and a photographing module n may capture an n-th visual image.

The tracking unit 120 according to an embodiment of the present disclosure detects and tracks the object in the images of the real scene, and thus obtains status information 220 of the object. For example, the tracking unit 120 may track a location, a shape, or a motion of the object. The tracking unit 120 may include a plurality of sensors, such as a depth sensor, for example. The tracking unit 120 may be implemented by being included in the plurality of photographing modules 110 that include a depth camera.

The image processor 130 according to an embodiment of the present disclosure may receive the images 210 of the real scene captured by using the plurality of photographing modules 110 from a plurality of viewing angles. Also the image processor 130 may receive the status information 220 of the object in the images of the real scene, which is obtained by the tracking unit 120. Based on the status information 220 of the object, the image processor 130 may determine status information 230 of the virtual image that corresponds to the real scene. Based on the status information 230 of the virtual image, the image processor 130 may combine the virtual image and the images of the real scene, thereby generating augmented reality images, i.e., rendering images 240 from the plurality of different viewing angles. The image processor 130 may be implemented by using a computing apparatus such as a workstation, a desktop computer, or a tablet PC.

Based on the status information 230 of the virtual image, the image processor 130 according to an embodiment of the present disclosure may generate the transparent model that corresponds to the object. In order to generate a screening effect in a portion of the virtual image that is to be located at the back of the object and be covered by the object, the image processor 130 may overlay the transparent model on the object.

Alternatively, based on the status information 220 of the object, the image processor 130 may generate the transparent model that corresponds to the object. In order to generate a screening effect in a portion of the virtual image that is to be in the back of the object and be covered by the object, the image processor 130 may overlay the transparent model on the object.

The rendering unit 140 according to an embodiment of the present disclosure may include a plurality of renderable cameras. The plurality of renderable cameras may be disposed to correspond to the plurality of photographing modules 110. Internal parameters and external parameters of the plurality of renderable cameras may be determined such that they correspond to parameters of the plurality of photographing modules 110.

The rendering unit 140 according to an embodiment of the present disclosure may match a rendering area to a display area of a display unit 250 to render the images of the real scene and the virtual image. The plurality of renderable cameras may render the rendering images 240 from the plurality of different viewing angles.

The display unit 250 according to an embodiment of the present disclosure may display the augmented reality image that is generated by the image processor 130. The display unit 250 may be implemented by using a polarized 3D display, a time sharing 3D display, a head mounted display (HMD) 3D display, a chrominance 3D display, a parallax barrier 3D display, or a lenticular 3D display, for example, but is not limited thereto.

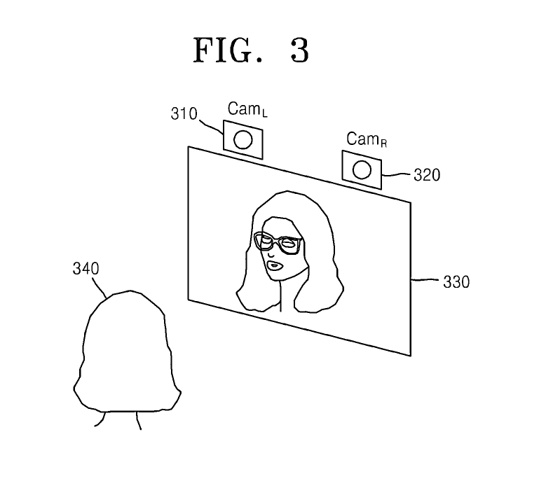

FIG. 3 is a view of the augmented reality apparatus 100 providing a virtual glasses try-on service, according to an embodiment of the present disclosure.

As illustrated in FIG. 3, augmented reality apparatus 100 providing the virtual glasses try-on service according to an embodiment of the present disclosure includes a left camera 310 and a right camera 320 as the plurality of photographing modules 110, and a tracking unit (not shown), an image processor (not shown), a rendering unit (not shown), and a 3D display 330.

The left and right cameras 310 and 320 may capture images of a real scene that includes an object 340, respectively from a left viewing angle and a right viewing angle.

The image processor may include the tracking unit. The tracking unit may use a depth sensor to track a head of the object 340. The tracking unit may use at least one of the left and right cameras 310 and 320 to obtain status information such as a location, a shape, or a motion, for example, of the head of the object 340.

The image processor may determine status information of a virtual glasses image so that the virtual glasses image is appropriately located at the head of the object 340, based on the status information of the object 340. The image processor may combine the virtual glasses image and the images of the real scene based on the determined status information.

The rendering unit may render an image combined at the left and right viewing angles.

An augmented reality image may be displayed by using a 3D display.

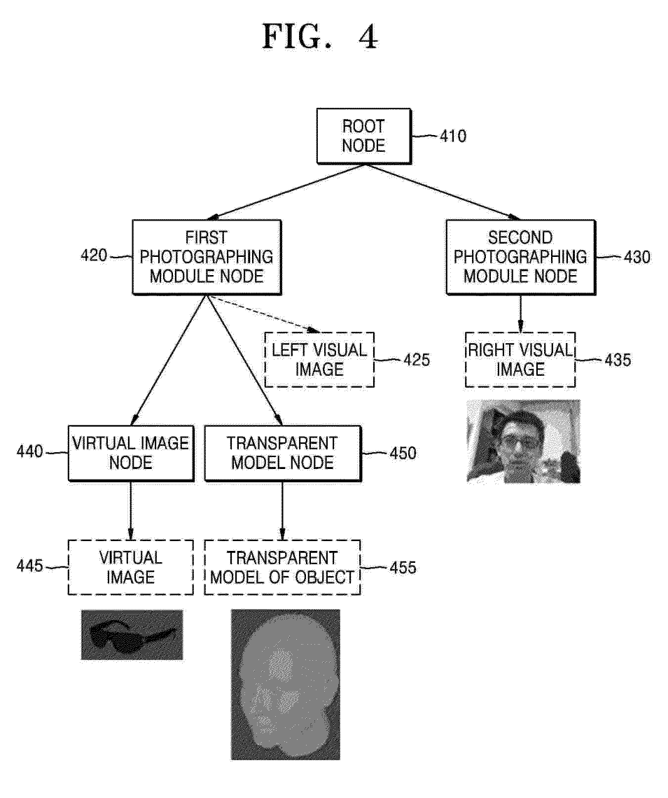

FIG. 4 is a data structure of the augmented reality apparatus 100 providing the virtual glasses try-on service, according to an embodiment of the present disclosure.

The data structure illustrated in FIG. 4 is a tree structure, in which each node has at least one child node and includes at least one image related to the at least one child node. The at least one image may include a 3D model.

As illustrated in FIG. 4, a root node 410 may have a first photographing module node 420 and a second photographing module node 430. The first and second photographing module nodes 420 and 430 may respectively store a left viewing angle image 425 and a right viewing angle image 435. The first photographing module node 420 may connect a virtual image node 440 that includes a virtual glasses image 445, and a transparent model node 450 that includes a transparent model 455 of an object.

The tracking unit 120 may detect and track in real time a head of the object in an image of a real scene 425 and 435 captured by a photographing module 110, and thus obtain status information of the object. Based on the status information of the head of the object, the image processor 130 may determine status information of the transparent model 455, such as a location, a size, a shape, or a motion, for example, of the transparent model 455 that corresponds to the object. Based on the status information of the transparent model 455, the image processor 130 may dispose the virtual glasses image 445 at an appropriate location and in an appropriate direction.

The rendering unit 140 may determine an image rendering order to appropriately generate a screening effect. For example, the rendering unit 140 may render the image of the real scene 425 and 435, the transparent model 455 of the object, and the virtual glasses image 445 so that a portion of the virtual glasses image that is to be located at the back of the object is covered by the object, or a portion of the object that needs to be located the back of the virtual glasses image is covered by the virtual glasses image.

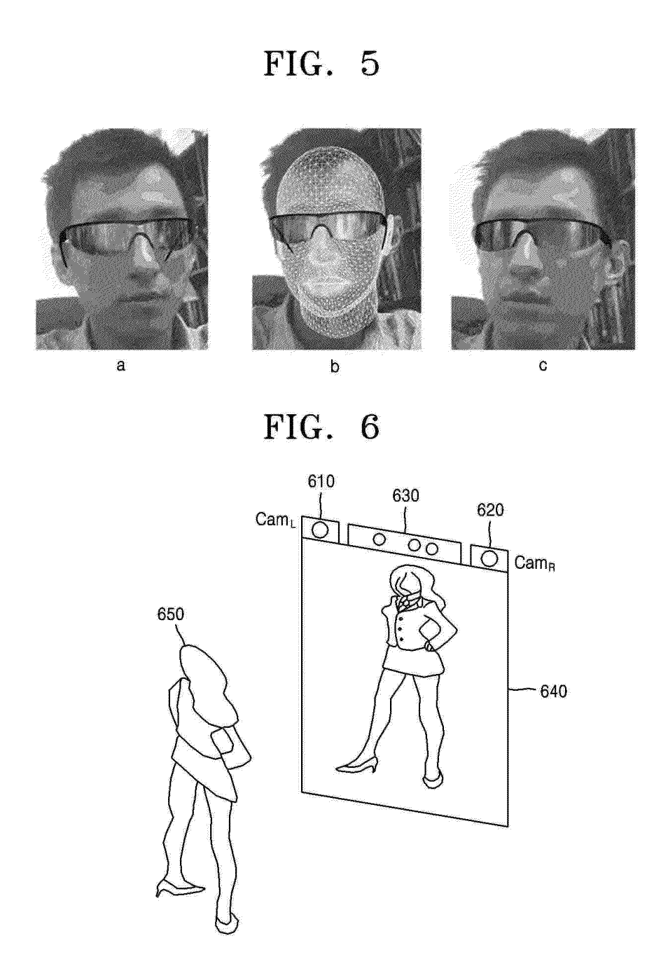

FIGS. 5A, 5B, and 5C illustrate generating the screening effect by using the transparent model of the object, according to an embodiment of the present disclosure.

FIG. 5A shows the augmented reality apparatus 100 according to an embodiment of the present disclosure displaying the virtual image on the object while not applying the screening effect. In FIG. 5A, a portion of the virtual glasses image that is to be covered by the head of the object is displayed without the screening effect.

FIG. 5B shows the augmented reality apparatus 100 according to an embodiment of the present disclosure generating the transparent model that corresponds to the head of the object, and thus generating the screening effect so that the portion of the virtual glasses image that is to be covered by the head of the object is covered by the transparent model. The transparent model is generated such that a shape, a size, a location, and motions thereof correspond to the object, and is used to generate the screening effect of the virtual image, but the transparent model itself is not displayed.

As a result, the augmented reality image may be displayed as in FIG. 5C.

The augmented reality apparatus 100 according to an embodiment of the present disclosure may track the object, and provide real time updates of the status information of the transparent model and the virtual image as the status information of the object is updated.

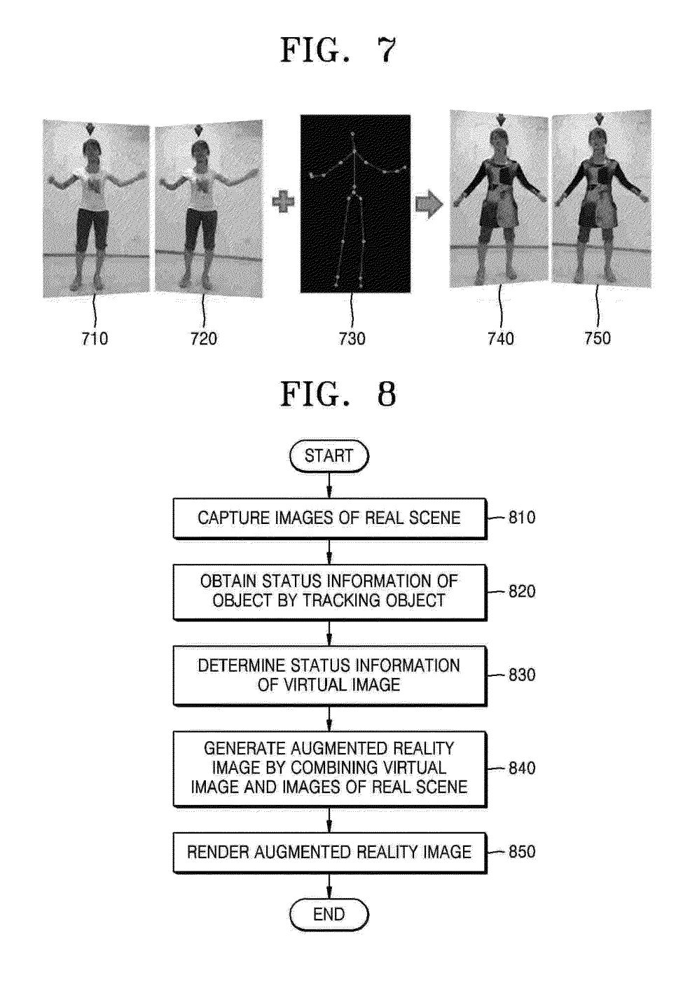

FIGS. 6 and 7 are views of the augmented reality apparatus 100 providing a virtual clothing try-on service, according to an embodiment of the present disclosure.

As illustrated in FIG. 6, the augmented reality apparatus 100 providing the virtual clothing try-on service according to an embodiment of the present disclosure includes a left camera 610 and a right camera 620 as the plurality of photographing modules 110, a tracking unit 630, an image processor (not shown), a rendering unit (not shown), and a 3D display 640.

The left and right cameras 610 and 620 may captures images of a real scene that includes an object 650, respectively from a left viewing angle and a right viewing angle.

The tracking unit 630 may include a depth sensor that may detect a location, a shape, or a motion of the object 650.

The image processor may determine status information of a virtual clothing image so that the virtual clothing image is appropriately located on an image of the object 650, based on the status information of the object 650. The image processor may combine the virtual clothing image and the images of the real scene based on the determined status information.

The rendering unit may render combined images at the left and right viewing angles.

An augmented reality image may be displayed by using a 3D display.

Referring to FIG. 7, the augmented reality apparatus 100 according to an embodiment of the present disclosure may use the plurality of photographing modules 110 to capture the images of the real scene that includes the object to obtain a left image 710 and a right image 720.

The tracking unit 120 according to an embodiment of the present disclosure may use at least one of the captured images to detect an object in the real scene. Also, the tracking unit 120 may track the object 730, and thus obtain status information of the object, such as a location, a shape, or a motion of the object.

Based on the status information of the object, the image processor 130 according to an embodiment of the present disclosure determines status information of the virtual clothing image, and combines the virtual clothing image and the images of the real scene. The image processor 130 may provide real time updates of the status information of the virtual clothing image as the status information of the object is updated.

The rendering unit 140 according to an embodiment of the present disclosure may render an augmented reality image generated by combining the virtual clothing image and the images of the real scene. The rendering unit 140 may use the plurality of renderable cameras to render a combined image 740 obtained from the left viewing angle and a combined image 750 obtained from the right viewing angle.

FIG. 8 is a flowchart of an augmented reality method, according to an embodiment of the present disclosure

In operation 810, the augmented reality apparatus 100 according to an embodiment of the present disclosure captures the images of the real scene that includes the object, from the plurality of viewing angles.

In operation 820, the augmented reality apparatus 100 according to an embodiment of the present disclosure tracks the object in the images of the real scene, and thus obtains the status information of the object.

In operation 830, the augmented reality apparatus 100 according to an embodiment of the present disclosure determines the status information of the virtual image that corresponds to the real scene, based on the status information of the object.

In operation 840, the augmented reality apparatus 100 according to an embodiment of the present disclosure generates the augmented reality image by combining the virtual image and the images of the real scene, based on the determined status information.

The augmented reality apparatus 100 according to an embodiment of the present disclosure may generate the transparent model that corresponds to the object, based on at least one of the status information of the virtual image and the status information of the object. The augmented reality apparatus 100 may overlay the transparent model on the object to generate the screening effect between the virtual image and the object. The augmented reality apparatus 100 may combine the virtual image and the images of the real scene, and thus generate an augmented reality image to which the screening effect is applied.

In operation 850, the augmented reality apparatus 100 according to an embodiment of the present disclosure renders the augmented reality image.

The augmented reality apparatus 100 according to an embodiment of the present disclosure may be implemented in an electronic device that may display in 3D.

The augmented reality apparatus 100 according to an embodiment of the present disclosure may provide a 3D try-on service to a user.

As described above, according to the one or more of the above embodiments of the present disclosure, a virtual try-on service may be provided by using an augmented reality technology and a 3D display technology.

One or more embodiments of the present disclosure can be implemented through computer readable code/instructions, such as a computer-executed program module, in/on a medium, e.g., a computer readable medium. The computer readable medium may be a random computer-accessible medium, and may include volatile media, non-volatile media, separable media and/or non-separable media. Also, the computer readable medium may correspond to any computer storage media and communication media. The computer storage media includes volatile media, non-volatile media, separable media and/or non-separable media which are implemented by using a method or technology for storing information, such as computer readable code/instructions, data structures, program modules, or other data. The communication media generally includes computer readable code/instructions, data structures, program modules, or other transmission mechanisms, and random information transmission media.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

It should be understood that the exemplary embodiments described therein should be considered in a descriptive sense only and not for purposes of limitation. Descriptions of features or aspects within each embodiment should typically be considered as available for other similar features or aspects in other embodiments. For example, a single element may be separately implemented, and separate elements may be implemented in a combined form.

While one or more embodiments of the present disclosure have been described with reference to the figures, it will be understood by those of ordinary skill in the art that various changes in form and details may be made therein without departing from the spirit and scope of the present disclosure as defined by the following claims.

What is claimed is:

1. An augmented reality apparatus comprising:
a plurality of photographing modules that are separated from each other, the plurality of photographing modules capturing images of a real scene that comprises an object;
a tracking unit obtaining status information of the object by tracking the object in the images of the real scene;
an image processor determining status information of a virtual image that corresponds to the real scene based on the status information of the object, and generating an augmented reality image by combining the virtual image and the images of the real scene based on the determined status information of the virtual image; and
a rendering unit rendering the augmented reality image to display the augmented reality image.

2. The apparatus of claim 1, wherein, based on the status information of the virtual image, the image processor generates a transparent model that corresponds to the object, and then overlays the transparent model on the object to generate a screening effect between the virtual image and the object.

3. The apparatus of claim 1, wherein, based on the status information of the object, the image processor generates a transparent model that corresponds to the object, and then overlays the transparent model on the object to generate a screening effect between the virtual image and the object.

4. The apparatus of claim 1, wherein the rendering unit comprises a plurality of renderable cameras to render the virtual image and the images of the real scene.

5. The apparatus of claim 1, wherein the virtual image is a virtual glasses image,
wherein the plurality of photographing modules comprise a first camera and a second camera,
wherein at least one of the first and second cameras comprises the tracking unit, and
wherein the first camera captures a first image of the real scene from a left side, and the second camera captures a second image of the real scene from a right side.

6. The apparatus of claim 5, wherein the image processor uses at least one of the first and second cameras that comprises the tracking unit from among the first and second camera to track a head of the object and obtain status information of the head of the object; determines status information of the virtual glasses image that corresponds to the real scene based on the status information of the head of the object; and generates an augmented reality image by overlaying the virtual glasses image on the head of the object based on the determined status information.

7. The apparatus of claim 1, wherein the virtual image is a virtual clothing image,
wherein the plurality of photographing modules comprise a first camera and a second camera,
wherein at least one of the first and second cameras comprises the tracking unit, and
wherein the first camera captures a first image of the real scene from a left side, and the second camera captures a second image of the real scene from a right side.

8. The apparatus of claim 7, wherein the image processor comprises a depth sensor for obtaining shape information of the object, determines shape information of the virtual clothing image based on the shape information of the object that is obtained by the depth sensor, changes a shape of the virtual clothing image based on the determined shape information, and generates an augmented reality image by overlaying a changed virtual clothing image on the object, and
wherein the rendering unit renders the augmented reality image at the left and right sides from which the images of the real scene are captured.

9. The apparatus of claim 1, wherein the plurality of photographing modules comprises a plurality of tracking cameras comprising a tracking unit,
wherein the rendering unit comprises a plurality of renderable cameras, and
respective parameters of the plurality of renderable cameras are determined correspondingly to respective parameters of the plurality of tracking cameras.

10. The apparatus of claim 1, further comprising a display unit displaying a rendered augmented reality image.

11. An augmented reality method comprising:
capturing images of a real scene that comprises an object from a plurality of viewing angles;
obtaining status information of the object by tracking the object in the images of the real scene;
determining status information of a virtual image that corresponds to the real scene based on the status information of the object;
generating an augmented reality image by combining the virtual image and the images of the real scene based on the determined status information; and
rendering the augmented reality image.

12. The method of claim 11, wherein the generating of the augmented reality image comprises:
generating a transparent model that corresponds to the object based on the status information of the virtual image;
overlaying the transparent model on the object to generate a screening effect between the virtual image and the object; and
generating an augmented reality image to which the screening effect is applied by combining the virtual image and the images of the real scene.

13. The method of claim 11, wherein the generating of the augmented reality image comprises:
generating a transparent model that corresponds to the object based on the status information of the object;
overlaying the transparent model on the object to generate a screening effect between the virtual image and the object; and
generating an augmented reality image to which the screening effect is applied by combining the virtual image and the images of the real scene.

14. The method of claim 11, wherein the rendering of the augmented reality image comprises rendering the virtual image and the images of the real scene by using a plurality of rendering units.

15. The method of claim 11, wherein the virtual image is a virtual glasses image, and
wherein the images of the real scene are captured from a left side and a right side.

16. The method of claim 15, wherein the obtaining of the status information of the object comprises using at least one of the images of the real scene captured from the left and right sides, tracking a head of the object, and thus obtaining status information of the head of the object,
wherein the determining of the status information of the virtual image comprises determining status information of the virtual glasses image that corresponds to the real scene based on the status information of the head of the object,
wherein the generating of the augmented reality image comprises generating an augmented reality image by overlaying the virtual glasses image on the head of the object based on the determined status information, and
wherein the rendering of the augmented reality image comprises rendering the augmented reality image at the left and right sides from which the images of the real scene are captured.

17. The method of claim 11, wherein the virtual image is a virtual clothing image, and
wherein the images of the real scene are captured from a left side and a right side.

18. The method of claim 17, wherein the obtaining of the status information of the object comprises using a depth sensor to obtain shape information of the object,
wherein the determining of the status information of the object comprises determining shape information of the virtual clothing image based on the shape information of the object obtained by the depth sensor,
wherein the generating of the augmented reality image comprises changing a shape of the virtual clothing image based on the determined shape information, and generating an augmented reality image by overlaying the changed virtual clothing image on the object, and
wherein the rendering of the augmented reality image comprises rendering the augmented reality image at the left and right sides.

19. A non-transitory computer-readable recording medium having recorded thereon a program, which, when executed by a computer, performs the method of claim 11.

20. A method of providing a three-dimensional virtual display, the method comprising:
obtaining a first image comprising a first viewpoint of a first object;
obtaining a second image comprising a second viewpoint of the first object;
tracking the first object;
generating a virtual image of a second object corresponding to the tracked first object; and
generating a three-dimensional virtual image by combining the first image, the second image, and the virtual image.
